(19) United States
(12) Patent Application Publication
(10) Pub. No.: US 2011/0174591 A1
(43) Pub. Date: Jul. 21, 2011

(54) Automatic Diameter Ascertainment of Coins

(75) Inventor: Hannes Schimpl, Gallneukirchen (AT)

(73) Assignee: NOVOTECH ELEKTRONIK GMBH, Engerwitzdorf (AT)

(21) Appl. No.: 13/071,101

(22) Filed: Mar. 24, 2011

Related U.S. Application Data
(63) Continuation of application No. PCT/EP2009/062977, filed on Oct. 6, 2009.

(30) Foreign Application Priority Data
Oct. 7, 2008 (AT) 1566/2008

(51) Int. Cl. G07F 9/00; F21S 4/00; H01J 40/14

(52) U.S. Cl. 194/342; 362/249.02; 250/216

(57) ABSTRACT

A device for recognizing coins and conveyed material similar to coins includes: at least one divergent light source; at least one light detector; and a conveyor configured to transport the conveyed material in a conveyor direction, the conveyor running in a recognition area between the at least one divergent light source and the at least one light detector, the conveyor including a centering unit for the centric orientation of the conveyed material relative to the linear detection area. The at least one light detector has a linear detection area parallel to the conveyor direction. The diameter of the conveyed material is illuminated in the conveyor direction using the at least one divergent light source and projected onto the at least one light detector. The illuminated diameter is repeatedly measured and determined by subsequent mean value calculation.

### CROSS REFERENCE TO RELATED APPLICATIONS

This application is a continuation of International Application No. PCT/EP2009/062977, filed on Oct. 6, 2009, entitled “Automatic Diameter Determination of Coins,” which claims priority under 35 U.S.C. §119(a)-(d) to Application No. AT 1566/2008 filed on Oct. 7, 2008, entitled “Automatic Diameter Determination of Coins,” the entire contents of which are hereby incorporated by reference.

### FIELD OF THE INVENTION

The invention relates to a device for recognizing coins and conveyed material similar to coins with the aid of at least one light source and at least one light detector, and a conveyor for transporting the isolated conveyed material, the conveyor running in a recognition area between the at least one light source and the at least one light detector. Furthermore, the invention relates to a method for recognizing coins and conveyed material similar to coins.

### BACKGROUND

Devices according to the species for coin recognition are typically based on the use of laser light, since the linear, i.e., parallel propagation of the laser light allows precisely accurate scanning of the conveyed material, and therefore a simple measurement. The conveyed material is moved through one or more laser beams, and information is obtained from the interruption of the laser beam by the conveyed material, which allows an identification of the corresponding conveyed material. However, the use of laser light also has disadvantages in practice, since the precision of the precisely accurate measurement is reduced by short-term interfering influences, such as movements of the conveyed material, or interruptions or impairments of the light beam. Devices based on laser light have thus also proven to be sensitive to dirt.

Light sources for divergent light bundles, in particular for incoherent light, are typically not used, since the use of optics typically appears necessary for this purpose, which is in turn connected to disadvantages. Thus, for example, the lenses of such optics must be aligned and cleaned repeatedly.

### SUMMARY

It is therefore the object of the invention to implement a device and a method for recognizing coins and conveyed material similar to coins, which do not have these disadvantages, and allow, on the one hand, reliable recognition of the conveyed material even in the event of short-term interfering influences, such as movements of the conveyed material or impairments of the light beams, and, on the other hand, are also insensitive with respect to soiling. The device according to the invention is to be simply constructed and therefore also cost-effective.

These objects are achieved by a device for recognizing coins and conveyed material similar to coins with the aid of at least one light source and at least one light detector, and a conveyor for the transport of the isolated conveyed material, the conveyor running in a recognition area between the at least one light source and the at least one light detector. It is provided according to the invention for this purpose that the at least one light source is a light source for divergent light bundles, and the at least one light detector has a linear detection area parallel to the conveyor direction, the conveyor having a centering unit for the centric orientation of the conveyed material relative to the linear detection area.

Therefore, divergent light bundles are used according to the invention, so that the use of laser light having parallel light propagation, or lenses and the like, and the disadvantages connected thereto are avoided. Divergent light bundles are understood here as light bundles having nonparallel edge beams, in contrast, for example, to laser light having parallel light propagation, the convergence of the light bundle being in the magnitude of the conveyed material to be measured.

The supposedly lesser precision of a measurement with the aid of non-punctiform, i.e., divergent light is compensated for by additional measures, with the aid of a repeated measurement of a defined diameter of the conveyed material, namely that in the conveyor direction. This is achieved in that, on the one hand, the at least one light detector has a linear detection area parallel to the conveyor direction, on which the diameter of the conveyed material is imaged in the conveyor direction, and the conveyor has a centering unit for the centric orientation of the conveyed material relative to the linear detection area. Because of the repeated measurement, a mean value can finally be calculated, which compensates for short-term interfering influences during the measurement, and increases the precision of the recognition. The applicant has established that with the aid of the measures according to the invention, precisions of the recognition may be achieved which are entirely in the range of devices based on laser light, without having the disadvantages connected to these devices, however.

According to a preferred embodiment of the invention, furthermore, a first group of light sources can be situated so that their respective optical axis is oriented perpendicularly to the conveyed material, and a second group of light sources can be situated so that their respective optical axis is oriented diagonally to the conveyed material. The first group is thus suitable for determining the diameter of the conveyed material, and the second group is thus suitable for determining the lateral surface shape of the conveyed material, i.e., whether the lateral surface is, for example, smooth, milled, or raised, or also how thick the conveyed material is. The device is thus also suitable for recognizing conveyed material similar to coins, such as round conveyed material having drilled holes, similar to a washer, and therefore, for example, for checking such objects for internal and external diameter or offset, since the edge positions are analyzed, and not merely the covered surface.

The light sources are preferably LEDs (light-emitting diodes). Such light sources are cost-effective and robust. The at least one light detector is preferably at least one photodiode line. Two photodiode lines may also be provided, which are situated one behind another parallel to the conveyor direction. If their scanning of the diameter is synchronized, interfering influences of the movement of the conveyed material may be additionally reduced.

According to a preferred embodiment of the invention, it can further be provided that the conveyor is implemented as an inclined conveyor, and the centering unit comprises pairs of bolts, the linear detection area being situated in a plane of symmetry between the two bolts. This represents a simple implementation of the centering unit. Specifically, the conveyed material is securely received by the two bolts because of gravity due to the inclined configuration of the conveyor in the recognition area. If the linear detection area is situated in a plane of symmetry between the two bolts, the conveyed material is automatically centered relative to the linear detection area, so that the diameter of the conveyed material is measured in the conveyor direction.

A simple embodiment of the conveyor provides, for example, that the conveyor comprises two parallel toothed belts, one bolt being situated on each of the two toothed belts. A middle web, which protrudes slightly beyond the two toothed belts, can be provided in the recognition area between the toothed belts. The conveyed material is thus dragged along via the middle web by the conveying bolts, so that reliable centering and smooth mounting between the bolts is ensured in the recognition area, whereby uniform scanning of the conveyed material is ensured.

To improve the precision of the measurement, a regulation for the brightness of the light sources can further be provided, in order to keep the brightness of the light sources constant.

Furthermore, according to the invention, a method for recognizing coins and conveyed material similar to coins with the aid of at least one light source and at least one light detector, as well as a conveyor, which moves the isolated conveyed material along a conveyor direction between the at least one light source and the at least one light detector in a recognition area, is proposed. It is provided in this case according to the invention that in a first method step, the diameter of the conveyed material is illuminated in the conveyor direction using a first group of light sources for divergent light bundles, whose respective optical axis is oriented perpendicularly to the conveyed material, and projected onto the at least one light detector, the illuminated diameter being repeatedly measured and being determined by subsequent mean value calculation. The measures according to the device for ensuring a projection of the diameter of the conveyed material in the conveyor direction were explained above, in that namely, on the one hand, the at least one light detector has a linear detection area parallel to the conveyor direction, and the conveyor has a centering unit for the centric orientation of the conveyed material relative to the linear detection area.

Finally, it can be provided that in a second method step, the diameter of the conveyed material is illuminated in the conveyor direction by a second group of light sources for divergent light bundles, whose respective optical axis is oriented diagonally to the conveyed material, the illuminated diameter being repeatedly measured and the lateral surface shape of the conveyed material being determined by subsequent mean value calculation.

The first and second method steps may also be executed repeatedly one after another, i.e., following the second method step, further sequences having first and second method steps.

### BRIEF DESCRIPTION OF THE DRAWINGS

The invention is explained in greater detail hereafter on the basis of an exemplary embodiment with the aid of the appended drawings. In the figures:

FIG. 1 shows a schematic illustration of a side view of an embodiment of a device according to the invention during the performance of the second method step,

FIG. 2 shows the embodiment according to FIG. 1 from above,

FIG. 3 shows the side view of the embodiment according to FIG. 1 during the performance of the first method step,

FIG. 4 shows a schematic illustration of a side view of a further embodiment of a device according to the invention during the performance of the second method step, and

FIG. 5 shows the side view of the embodiment according to FIG. 4 during the performance of the first method step.

### DETAILED DESCRIPTION

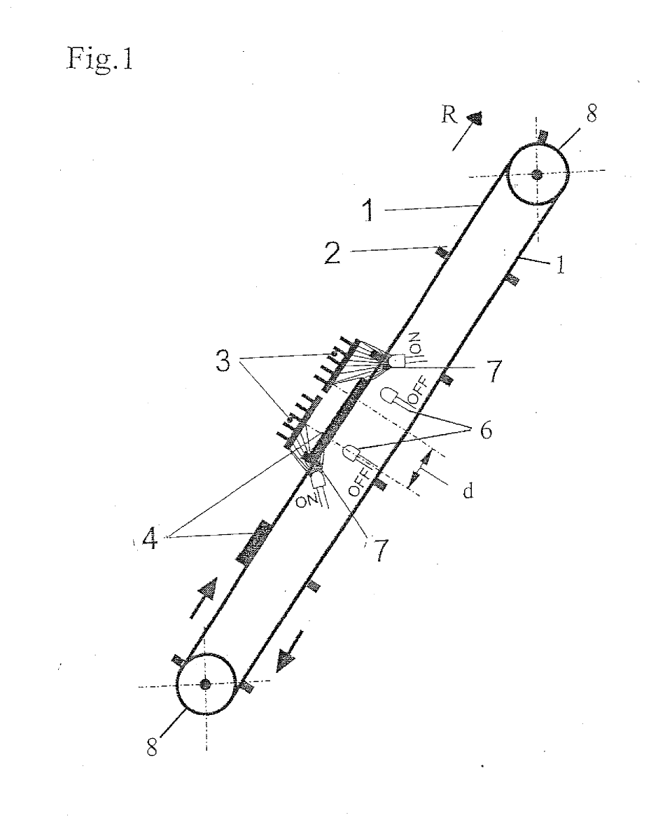

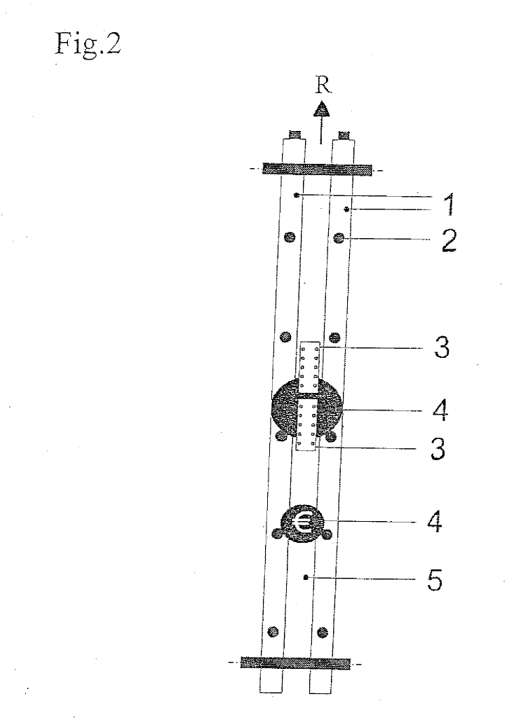

FIG. 1 shows a schematic illustration of a side view of a device according to the invention having a conveyor 1, which is implemented in the exemplary embodiment shown as an inclined conveyor having two parallel toothed belts. The conveyor 1 is provided with pairs of bolts 2, one bolt 2 being situated on each of the two toothed belts. The bolts 2 are used, on the one hand, as drivers for the conveyed material 4 similar to coins, and, on the other hand, as a centering unit, as explained in greater detail hereafter. Furthermore, a middle web 5 can be situated between the toothed belts at least in the recognition area (see FIG. 2), which protrudes slightly beyond the two toothed belts. The conveyed material 4 is thus dragged along via the middle web 5 by the conveying bolts 2, so that in the recognition area, reliable centering and smooth mounting is ensured between the bolts 2, whereby uniform scanning of the conveyed material 4 is ensured. The two toothed belts are driven, for example, by a common gearwheel 8, so that horizontal positioning of the conveyed material 4 which remains uniform is ensured. A guide rail can also additionally be provided for each of the revolving toothed belts.

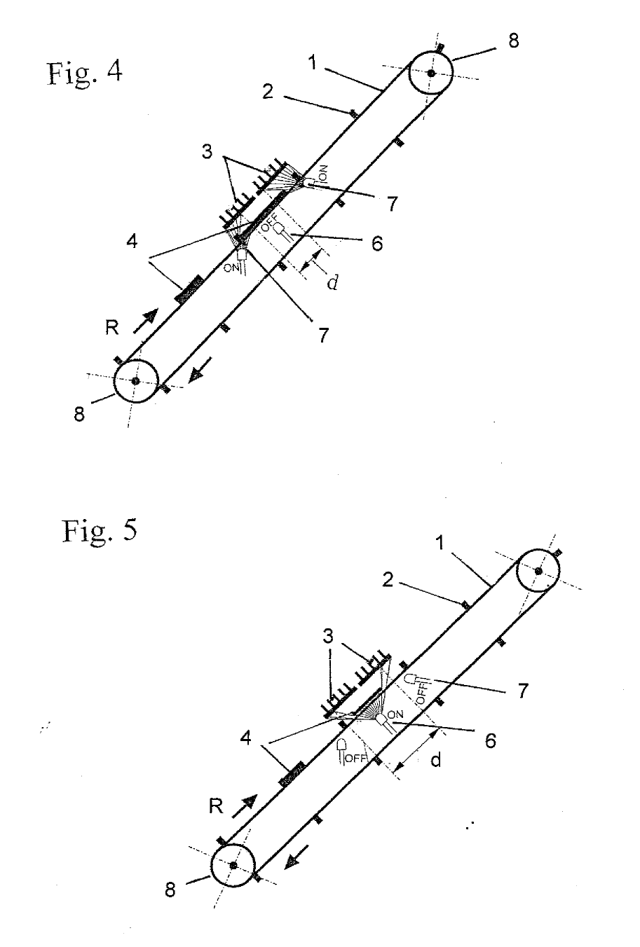

Light sources 6, 7 for divergent light bundles are situated in a recognition area below the conveyor 1, a first group of light sources 6 being situated so that their respective optical axis is oriented perpendicularly to the conveyed material 4, and a second group of light sources 7 being situated so that their respective optical axis is oriented diagonally to the conveyed material 4. The light sources 6, 7 are, for example, LEDs (light-emitting diodes), in particular also incoherent light sources. In the embodiment according to FIGS. 4 and 5, the first group of light sources 6 only comprises a single light source, whose optical axis is oriented perpendicularly to the conveyed material 4, whereby not only is the structure simplified, but rather improved precision of the measurement can also sometimes be achieved.

At least one light detector 3, which has a linear detection area parallel to the conveyor direction R, is situated above the conveyor 1. The at least one light detector 3 is, for example, a photodiode line, in the exemplary embodiment shown, two photodiode cells being provided, which are situated one behind another parallel to the conveyor direction R. If the linear detection area is situated in a plane of symmetry between the two bolts 2, the conveyed material 4 is automatically centered relative to the linear detection area, so that the diameter D of the conveyed material 4 is measured in the conveyor direction R. In this way, a simple centering unit can be implemented.

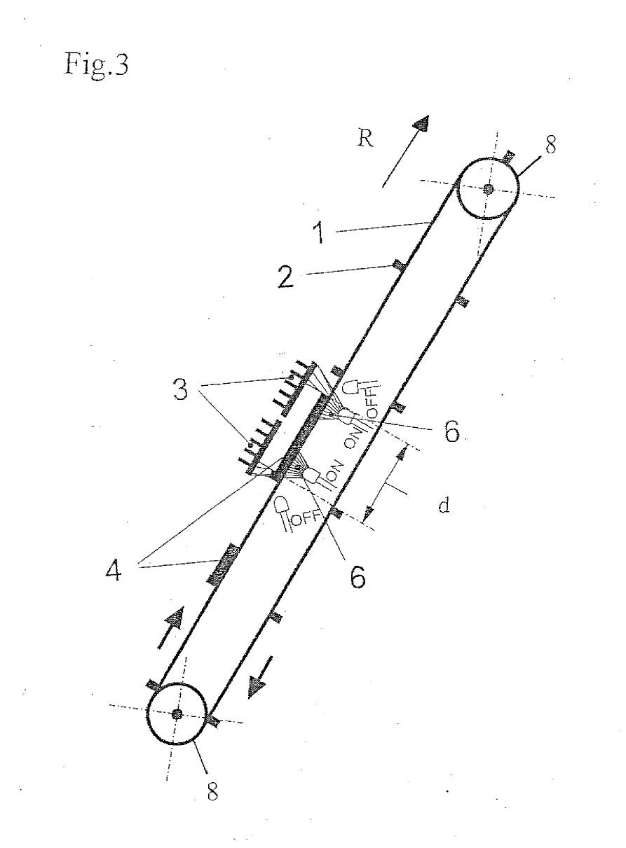

The diameter D of the conveyed material 4 is determined with the aid of the first group of light sources 6, which are situated centrically in relation to the photodiode lines 3, and whose divergent light propagation images the diameter of the conveyed material 4 in the conveyor direction R on the photodiode lines 3 (FIG. 3, FIG. 5). A value can thus be determined which is already very similar to the diameter D of the conveyed material 4 in the conveyor direction R. After a predefined number of scans during the transport of the conveyed material 4 through the recognition area, the first group of light sources 6 is turned off, and the diagonally situated, second group of light sources 7 is turned on. A predefined number of scans is again performed during the transport of the conveyed material 4 through the recognition area, until the projection of the conveyed material 4 on the photodiode lines 3 has reached the end of the photodiode line 3 (FIG. 1, FIG. 4). Measured values, which are very strongly dependent on the thickness d of the conveyed material 4, are obtained by the second group of light sources 7, which are situated diagonally to the conveyed material 4. Based on these measured values for the diameter D of the conveyed material 4 in the conveyor direction R, the diameter D and the lateral surface shape of the conveyed material 4, in particular the thickness d, can be determined by software. The sequence of first and second method steps can also be performed repeatedly one after another. Furthermore, the second method step can also be performed first, and then the first method step.

To improve the precision of the measurement, a regulation can also be provided for the brightness of the light sources 7, in order to keep the brightness constant. In particular in the case of the use of LEDs, the brightness of the light sources 7 is subject to a variation during their lifetime, or in the course of temperature changes. Since divergent light is used without the aid of lenses for measurement according to the invention, these variations could impair the measurement precision, so that a brightness regulation to compensate for these variations increases the precision.

Therefore, multiple measured values are determined by the repeated position determination of the conveyed material 4, which subsequently gain precision through mean value calculation. Therefore, short-term interferences, for example, movements of the conveyed material 4 or interruptions of the light propagation, may be filtered out by this mean value calculation. In this way, high precisions may be achieved, without being a function of only one projected maximum or apex value, as is the case if laser light is used, for example. Furthermore, because of the use of two different illumination angles and the divergent light, the lateral surface shape of the conveyed material 4 can also be checked, i.e., whether the lateral surface is, for example, smooth, milled, or raised, or also how thick the conveyed material 4 is.

The device according to the invention and the method according to the invention thus do not require optics, and are hardly sensitive to dirt, since the conveyed material 4 is illuminated from the bottom side, and the sensitive light detectors 3 are located above the conveyed material 4.

The invention thus implements a device and a method for recognizing coins and conveyed material similar to coins, in which, on the one hand, reliable recognition of the conveyed material is ensured even in the event of short-term interfering influences, such as movements of the conveyed material or impairments of the light beams, and, on the other hand, sensitivity with respect to contaminants is not provided. The device according to the invention is simply constructed and therefore also cost-effective.

What is claimed is:

1. A device for recognizing coin-like conveyed material, comprising:
at least one divergent light source;
at least one light detector; and
a conveyor configured to transport the conveyed material in a conveyor direction, the conveyor running in a recognition area between the at least one divergent light source and the at least one light detector, the conveyor including a centering unit for the centric orientation of the conveyed material relative to the linear detection area;
wherein the at least one light detector has a linear detection area parallel to the conveyor direction.

2. The device of claim 1, wherein the at least one divergent light source comprises a first group of light sources situated with their respective optical axes oriented perpendicularly to the conveyed material, and a second group of light sources situated with their respective optical axes oriented diagonally to the conveyed material.

3. The device of claim 1, wherein the at least one divergent light source comprises a light emitting diode (LED).

4. The device of claim 1, wherein the at least one light detector comprises a photodiode line.

5. The device of claim 4, wherein the at least one light detector comprises two photodiode lines situated one behind another parallel to the conveyor direction.

6. The device of claim 1, wherein the conveyor comprises an inclined conveyor, and the centering unit comprises first and second bolts, the linear detection area being situated in a plane of symmetry between the first and second bolts.

7. The device of claim 6, wherein the conveyor comprises first and second parallel toothed belts, the first bolt being situated on the first toothed belt and the second bolt being situated on the second toothed belt.

8. The device of claim 7, wherein the conveyor further comprises a middle web that protrudes beyond the first and second toothed belts and is situated in the recognition area between the first and second toothed belts.

9. The device of claim 1, further comprising a regulator configured to regulate a brightness of the at least one divergent light source to maintain a substantially constant brightness.

10. A method for recognizing coin-like conveyed material with the aid of at least one divergent light source, at least one light detector, and a conveyor that moves the conveyed material in a recognition area along a conveyor direction between the at least one divergent light source and the at least one light detector, the method comprising:
illuminating a diameter of the conveyed material in the conveyor direction using a first group of divergent light sources whose respective optical axes are oriented perpendicularly to the conveyed material and projected onto the at least one light detector;
repeatedly measuring the illuminated diameter of the conveyed material; and
determining the diameter of the conveyed material using a mean value calculation.

11. The method of claim 10, further comprising:
illuminating the diameter of the conveyed material in the conveyor direction using a second group of divergent light sources whose respective optical axes are oriented diagonally to the conveyed material;
repeatedly measuring the illuminated diameter of the conveyed material; and
determining a lateral surface shape of the conveyed material using a mean value calculation.
